(19) United States
(12) Patent Application Publication
(10) Pub. No.: US 2006/0267250 A1
(43) Pub. Date: Nov. 30, 2006

(54) Device and method for forming a non-ground vial

(76) Inventors: Herbert A. Gerretz, Estell Manor, NJ (US); Wayne Mozzo, Ocean City, NJ (US); Ivan E. Perez, Vineland, NJ (US)

Correspondence Address: RATNERPRESTIA, P O BOX 980, VALLEY FORGE, PA, 19482-0980, US

(21) Appl. No.: 11/136,202

(22) Filed: May 24, 2005

(51) Int. Cl. B29C 45/00; B29B 11/06

(52) U.S. Cl. 264/328.1; 425/547

(57) ABSTRACT

A method and device for making a vial from a pre-form having interior and exterior base portions and an interior and exterior side wall is provided. The device includes a heat source, at least one roller, a mandrel, and a means for forming the exterior base portion of the pre-form. The method for making the vial includes the steps of heating the pre-form to a temperature at or above the lowest temperature at which the pre-form flows, contacting the interior base portion with the mandrel, shaping the exterior side wall of the pre-form with the at least one roller, and forming the finished exterior base portion of the vial with a base forming means when the pre-from is at or above the temperature achieved in the heating step to form the finished vial base.

### FIELD OF THE INVENTION

The present invention is directed to a device and method of forming a vial, and more specifically, to a device and method of forming a flat-bottomed, transparent vial.

### BACKGROUND OF THE INVENTION

Handmade glass containers require the skill and dexterity of an experienced glass blower. One aspect of hand made glass containers is that each container is unique. Handmade glass containers are also, depending on the type of container, tedious and time consuming to manufacture. Although these features add to the value of an individually handmade glass container, these features are not beneficial when the purpose of making a glass container is to manufacture a large quantity of identically shaped and sized standard containers.

One glass container, in which the hand-made element has been removed from its manufacturing process, is the vial. A vial is generally characterized by its small cylindrical shape. Although, vials can be made from any number of materials including plastics, glass has been preferred. A vial is comprised of a base supporting a body, which defines a volume, and a finish. A finish is a term of art to describe the open end of the vial. A finish can be threaded to accept a screw cap or a serum can be formed to accept a crimping cap. The open end of the vial defined by the finish has an interior diameter, ID.

Vials are used in many different applications in the pharmaceutical and chemical industries. Vials can be handled individually or they can be manipulated by an automated machine. If a vial is to be used individually it is desirable that the vial have good stability when it is placed on a flat surface. If the vial is to be used in automated equipment, the stability of the vial standing alone is less important because common automated machines place vials in storage racks. One desirable feature of a vial to be used in an automated piece of equipment is that the bottom of the vial has a sufficient surface area and topography to allow a label to be affixed thereon.

### SUMMARY OF THE INVENTION

According to an exemplary embodiment of the present invention, a method for making a vial from a pre-form having interior and exterior base portions and an interior and exterior side wall includes heating the pre-form to a temperature at or above the lowest temperature at which the pre-form flows. The interior base portion is contacted with a mandrel to form the interior base. The exterior side wall is shaped with at least one roller. The finished base portion is formed with a base forming means when the pre-from is at or above the temperature achieved when the pre-form is heated, thereby forming the finished vial base.

An exemplary device of the present invention for making a vial from a pre-form having interior and exterior base portions, an interior and exterior side wall, and a finish has a heat source for raising the pre-form to a temperature at or above the lowest temperature at which the pre-form flows. Disposed adjacent the heat source is at least one roller to shape the exterior side wall of the pre-form. The device includes a mandrel adapted to be inserted through the finish end of the pre-form to contact the interior base portion of the pre-form. To form the exterior base portion of the vial, the device has a base forming means disposed coaxially with, and opposed to, the mandrel.

According to an exemplary embodiment, the method for making a vial of the present invention includes a method for making a glass extraction vial having a flat, transparent base and a finish. The transparent base glass vial is made by concurrently performing the following steps: providing a pre-form having interior and exterior base portions and an interior and exterior side wall, heating the pre-form to a temperature at or above the temperature at which the pre-from flows, inserting a mandrel into the pre-form through the finish to a point such that the mandrel contacts the interior base portion, shaping the exterior side wall of the pre-form with at least one roller, and forming the exterior base portion of the pre-form when the pre-form is at the temperature achieved in the heating step to form the flat, transparent base of the glass extraction vial.

### DRAWINGS

The invention is best understood from the following detailed description when read in connection with the accompanying drawing. It is emphasized that, of common practice, the various features of the drawing are not to scale only when the exact dimensions are not expressly stated. On the contrary, the dimensions of the various features are arbitrarily expanded or reduced for clarity. Included in the drawing are the following figures:

FIG. 1 illustrates an exemplary embodiment of a vial made by an exemplary embodiment of the device and method according to the present invention;

FIG. 2 illustrates an exemplary embodiment of a vial forming apparatus and a pre-form according to the present invention;

FIG. 3 illustrates an embodiment of a roller of the device for making a vial according to the present invention;

FIG. 4 is a flow chart of an exemplary embodiment of a method for making a vial according to the present invention;

FIG. 5 is a flow chart, describing in more detail, an exemplary embodiment of a method for making a vial according to the present invention;

FIG. 6 illustrates an exemplary embodiment of a vial forming apparatus and an exemplary embodiment of a finished vial according to the present invention;

FIG. 7 illustrates another exemplary embodiment of a vial made by an exemplary embodiment of the device and method according to the present invention; and

FIG. 8 illustrates yet another exemplary embodiment of a vial made by an exemplary embodiment of the device and method according to the present invention.

### DETAILED DESCRIPTION OF THE INVENTION

The extraction vials of the present invention are constructed of materials that are generally inert to most chemicals and will not interfere with the sensitivity of instruments that measure minute quantities of compounds contained in the vials. Suitable materials for the manufacture of vials of the present invention include polymeric materials and glass. Exemplary polymeric materials include polypropylene, polyethylene, and acrylics. Exemplary glass materials of the present invention include Type I borosilicate glass, amber (low actinic) borosilicate glass, amber glass, and soda-lime glass. As used herein, the term “glass” is used as a generic term and includes, but is not limited to, exemplary glasses of the present invention. The glass vials of the present invention may be reinforced or have their interior coated to impart advantageous qualities to the vials. For example, coating the interior of a vial with polypropylene prevents from the vial from floating when placed into a water bath.

The raw materials, e.g., polymeric materials and glass, that form the vials of the present invention, are thermally manipulated, and for glass, there is an entire body of knowledge describing the thermal manipulation process.

Generally, however, as the temperature of glass is increased from room temperature up to from about 1200° to about 1700° F., glass begins to transform from a solid to a more flowing form. At room temperature to about 1000° F., glass remains rigid and brittle. At temperatures above about 1000° F., any chemical imperfections or surface contaminants in the glass are burned off. At or above about 1000° F., the glass begins to soften slightly and the surface of the glass appears glossy. Between the temperatures of about 1300° F. to about 1400° F., the glass begins to flow and soften to a sufficient degree that it will conform to a mold. In this temperature range, the glass will glow a yellowish-red. If a glass piece has sharp edges, the edges may soften and round. Also in this temperature range, if two separate pieces of glass raised to these temperatures are made to contact each other, the pieces will stick together. Raising the temperature of glass in the range of about 1330° F. to about 1500° F. results in the color of the glass deepening and becoming a more intense red. Glass in this temperature range flows more readily, slumps completely, and starts to stretch out of shape. When glass reaches temperatures of above about 1500° F., full fusing of two pieces of glass occurs. At these temperatures, glass will glow an intense bright red. Any imperfections in the glass, such as an air bubble, will move toward the surface of the glass. Glass at temperatures above about 1700° F. cannot hold its shape and can be manipulated by combing, that is, by raking a tool across its surface. When glass is in this condition, it is generally referred to as molten glass and is in the temperature range from about 1650° F. to about 1750° F.

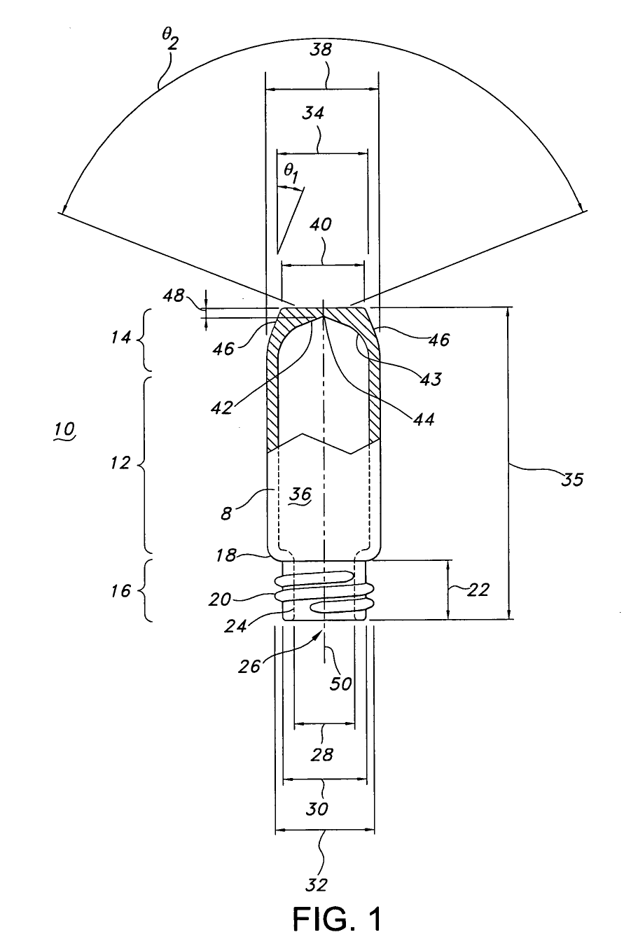

Referring now to the drawings, in which like reference numbers refer to like elements throughout the various figures that comprise the drawings, FIG. 1 illustrates an exemplary embodiment of a vial 10 made by an exemplary device and method according to an embodiment of the present invention. Vial 10 is defined by wall 8 and has generally cylindrical body 12, base portion 14, and top or neck portion 16. Vial 10 may be constructed with an interior volume ranging in size. Described below is an exemplary embodiment of a vial 10 made by an exemplary device and method according to the present invention. According to the exemplary embodiment shown in FIG. 1, vial 10 has approximately a 4.0 mL internal volume. Examples 1 and 2, described below, illustrate vial 10 having approximately 20 mL and 2.0 mL interior volumes, respectively. Other interior volumes consistent with the scope of this invention, such as 3.1 mL interior volumes, are also contemplated.

Between top or neck portion 16 and body 12 is rounded shoulder 18. Rounded shoulder 18 is formed from an arc of a circle having a radius in the range from about 3.5 mm to about 4.5 mm (for example 3.969 mm±about 0.3969 mm). Top or neck portion 16 is adapted to engage a lid or septum by frictional fit or a screw cap by threaded member 20, as shown in FIG. 1. Threaded member 20 has threads in the range of about 13-425 G.P.I. The height of top or neck portion 16, defined by distance 22 from shoulder 18 to lip 24 defining opening 26 is in the range of about 7-8.4 mm (for example 7.112-8.128 mm). Opening 26 has an interior diameter, ID, 28 of at least about 8 mm. The outside diameter 30 of top or neck portion 16 is in the range of about 11.0-11.9 mm (for example 11.15-11.53 mm) depending on the desired thickness of wall 8. The total width 32 of top or neck portion 16 is in the range of about 12-13.5 mm (for example 12.67-13.06 mm) depending on the height of the threads that comprise threaded member 20.

Base 14, body 12, and neck 16 have a height 35 ranging from about 44.0 mm to about 46.0 mm. The interior diameter 34 of cavity 36 is about 11.00 mm. The outer diameter 38 is in the range from about 14.48 mm to about 15.50 mm. Outer diameter 38 may continue into base 14, or as shown in FIG. 1, outer diameter 38 may taper along base wall 46 at base 14. The thickness of wall 8 at body 12 is about 1.2±0.1 mm.

At base 14, the thickness of wall 8 may vary. If outer diameter 38 remains constant at base 14, the thickness of wall 8 will increase. If outer diameter 38 tapers, as discussed above, the thickness of wall 8 may remain substantially constant. According to an embodiment of a vial formed by an embodiment of the device and method of the present invention, vial 10, shown in FIG. 1, has an outer diameter 38 that tapers along base wall 46 such that a flat exterior bottom 40 is formed having a diameter substantially the same as interior diameter 34. Flat bottom 40 increases the stability of the vial and also allows a bar-code or other identification to be directly affixed to the bottom of vial 10. Base wall 46 forms angle E₁ with respect to the outer diameter of vial 10. As shown in FIG. 1, Θ₁ is about 18°±5°. By maintaining angle Θ₁ at a minimum, vial 10 is less prone to topple when vial 10 is not secured, for example, in a rack used in automated sampling equipment.

In the interior of vial 10, base 14 defines surfaces 42 and 43, which converge at point 44 to form the interior base of vial cavity 36 and a generally concave surface. Point 44 lies on the center axis 50 of vial 10. Angle Θ₂ formed by converging surfaces 42 and 43 is about 120°. The distance 48 between point 44 and exterior bottom 40 is at least about 0.7 mm, for example about 0.838 mm.

An exemplary embodiment of a method for forming a vial according to the present invention begins with a length of tubing. For a glass vial, the length of tubing may have a wall thickness of approximately 3.2 mm±0.1 mm according to one exemplary embodiment, and a 1.10±0.05 mm wall according to another exemplary embodiment of the present invention. Suitable lengths of glass tubing are, for example, glass tubing W36130 manufactured by Durand.

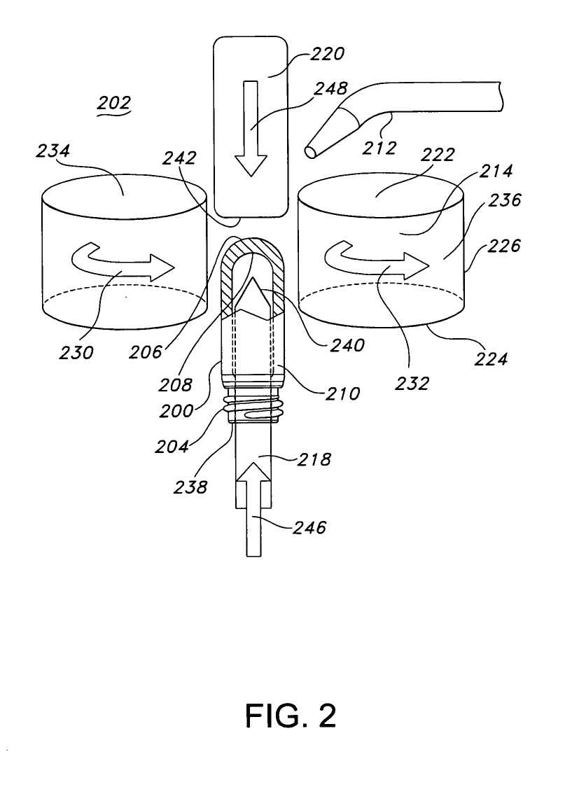

FIG. 2 illustrates an embodiment of a vial forming apparatus and a pre-form 200 according an embodiment of the present invention. As shown in FIG. 2, pre-form 200 has a threaded finish 204. Other finish ends, such as a crimp cap end, may also be formed. The end opposite the finish 204 has a generally rounded shape on its exterior 206 and in its interior base portions 208. This is partially due to a previous step in the method of making the vial that includes thermally cutting a predetermined length of tubing corresponding to a predetermined height of a finished vial. The thermal cutting process separates the predetermined length of tubing from the remaining tubing. As a result, the tubing flows together and forms a bulbous, rounded end with an un-formed exterior base portion 206 and an unfinished interior base portion 208.

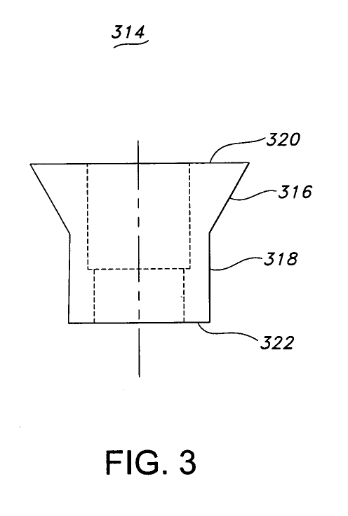

Shown in FIG. 2, is pre-from 200 with un-formed exterior base portion 206, and un-shaped exterior walls 210, before they are shaped and formed into a finished vial (shown in FIG. 3) by vial forming device 202. Vial forming device 202 includes a heat source 212, at least one roller 214 a mandrel 218, and a base forming means 220. Although FIG. 2 shows a single heat source 212, multiple heat sources may be used.

A step in an embodiment of the method of making a vial of the present invention includes shaping exterior side wall 210 of pre-form 200 with at least one roller 214. Roller 214, is shown in FIG. 2 as having a top 222, a base 224, and a substantially perpendicular side wall 226 to base 224 and top 222. Roller 214 is constructed of high heat resistant material, such as carbon. Perpendicular side wall 226 of at least one roller 214 imparts a substantially uniform side wall 210 to the vial. According to another embodiment, roller 226 has base 224 having a diameter and top 222 having a diameter that is dimensionally different than the base diameter.

Shown in FIG. 3 is another embodiment of a roller, namely roller 314. Roller 314 has a beveled edge 316 extending from its side wall 318 to a top 320 of roller 314. Top 320 of roller 314 has a diameter that is dimensionally larger than the diameter of base 322 of roller 314. With this embodiment of roller 314, the side wall of the finished vial can be formed having a beveled edge extending from the exterior side wall to the exterior base portion (shown by taper 46 in FIG. 1).

Referring again to FIG. 2, by contacting pre-form 200 with at least one roller 214, rotational movement shown by arrows 230 and 232 is imparted on pre-from 200. As shown in the embodiment of FIG. 2, at least one roller 214 includes a first 234 and a second roller 236. First roller 234 is diametrically opposed second roller 236, in between which is disposed pre-form 200. First and second rollers 234 and 236 are also disposed adjacent heat source 212. When rollers 234 and 236, spin in the directions of the arrows 232 and 230 shown in FIG. 2, pre-form 200 is made to spin. The rotational movement of pre-form 200 facilitates uniform heating and uniform formation of interior 208 and exterior base portions 206.

A step of forming a vial according to an embodiment of the present invention includes contacting the unfinished interior base portion 208 of pre-from 200 with mandrel 218. As shown in the embodiment of FIG. 2, mandrel 218 is inserted through finish end 238 of pre-from 200 until head 240 of mandrel 218 contacts unfinished interior base portion 208. According to an embodiment of the present invention, mandrel 218 has a head 240 having a V-shaped tip to form a V-shaped recess in interior base portion 208 when mandrel head 240 contacts interior base portion 208. Mandrel 218 can be made from any suitable material such as high tensile strength steel or carbon. Mandrel head 240 forming the tip is constructed of a carbon material such as those manufactured by Poco Specialties Graphites and Material.

Another step in an embodiment of the method of making a vial of the present invention includes forming a finished exterior base portion of a vial with base forming means 220 when pre-from 200 is at or above the temperature achieved in the heating step to form the finished vial base. As shown in the embodiment of FIG. 2, base forming means 220 is a high temperature resistant base forming rod constructed from graphite, for example, graphite manufactured by Poco Specialties Graphites and Material. Although base forming means 220 is shown in FIG. 2 as a rod, any suitable shape of base forming means 220 is contemplated so long as base forming means 220 has at least one surface 242 to contact the unformed exterior portion 206 of pre-from 200 during heating to shape the finished vial exterior base.

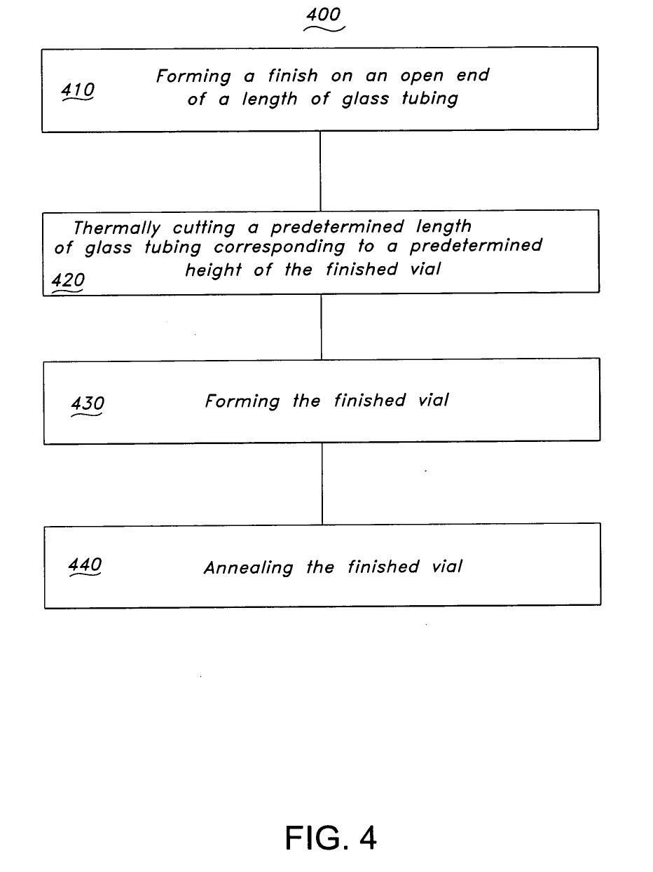

FIG. 4 is a flow chart of an exemplary method 400 of forming a vial according to an embodiment of the present invention. A finish is formed on an opened end of a predetermined length of tubing shown by block 410. The tubing with a finish end is then cut, preferably thermally cut, to a predetermined height (which at this step is referred to as a pre-form) that corresponds to a predetermined height of a finished vial shown by block 420. The pre-from is shaped and formed into a finished vial shown by block 430. The finished vial is then annealed as shown by block 440.

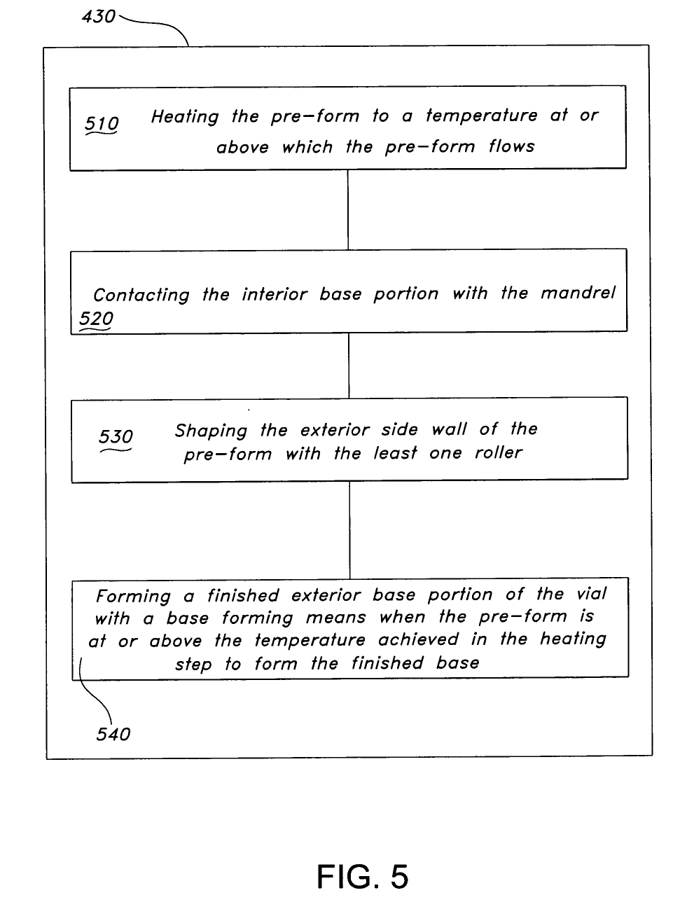

FIG. 5 is a flow chart showing, in more detail, the step of forming a vial 430 according to the present invention as shown in FIG. 4. According to the embodiment of the method shown in FIG. 5, the step of forming a vial 430 includes heating the pre-form to a temperature at or above the lowest temperature at which the pre-form flows shown by block 510, contacting the interior base portion with a mandrel shown by block 520, shaping the exterior side wall of the pre-form with at least one roller shown by block 530, and forming a finished exterior base portion of the vial with a base forming means when the pre-from is at or above the temperature achieved in said heating step to form the finished vial base shown by block 540.

According to another embodiment, the steps of contacting, shaping, and forming are performed concurrently, i.e., the steps overlap in duration. For example, the interior base portion and the exterior finished base portion may be formed and shaped concurrently, or even substantially at the same time. As shown in FIG. 2, mandrel 218 is disposed coaxially to and opposed with base forming means 220. When base forming means 220 and mandrel 218 move in the directions of the arrows 246 and 248 as shown in FIG. 2, the step of forming the exterior base portion and contacting the interior base portion occur concurrently. According to yet another embodiment of the method of the present invention, the step of shaping the exterior side wall of the pre-from may also occur concurrently with the steps of contacting the interior base portion and shaping the exterior side wall.

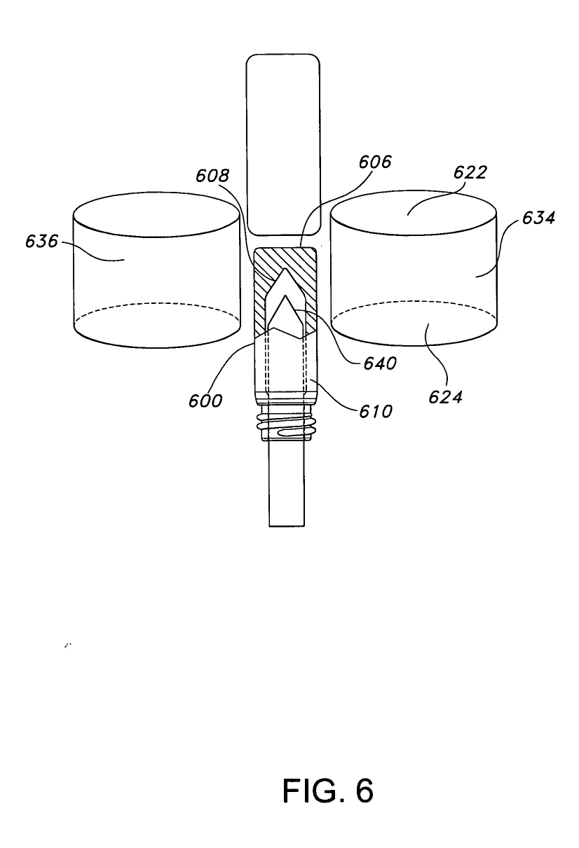

FIG. 6 illustrates a finished vial 600 after the steps of heating, contacting, shaping and forming have occurred. As is shown, the finished interior base portion 608 of vial 600 conforms to the shape of mandrel head tip 640. Also, as shown in the embodiment of FIG. 6, exterior side walls 610 are substantially perpendicular to exterior base portions 606 because the sides of rollers 634 and 636 are substantially perpendicular to the base 624 and top 622 of rollers.

### EXAMPLES

### Example 1

### 20 mL Vial

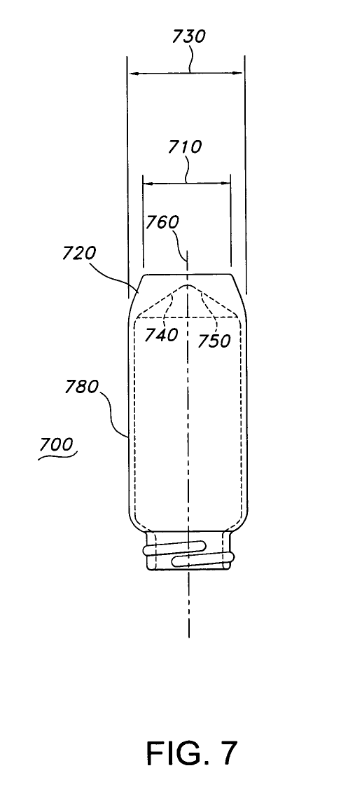

FIG. 7 illustrates vial 700 form by an exemplary method and device according to an embodiment of the present invention and having an interior volume of approximately 20 mL. Vial 700 of FIG. 7 has a 27.50±0.20 mm outer diameter 730 forming a 1.10±0.05 mm wall 780. Although the overall dimensions of vial 700 are generally larger than the 4.0 mL vial shown in FIG. 1, vial 700 has a base 710 that remains flat, and a base wall 720 that extends from base 710 to the outer diameter 730 to form an angle of approximately 18°±5°. Base 710 also defines an interior cavity having surfaces 740 and 750 that converge to point 760 forming a generally concave shape.

### Example 2

### 2.0 mL Vial

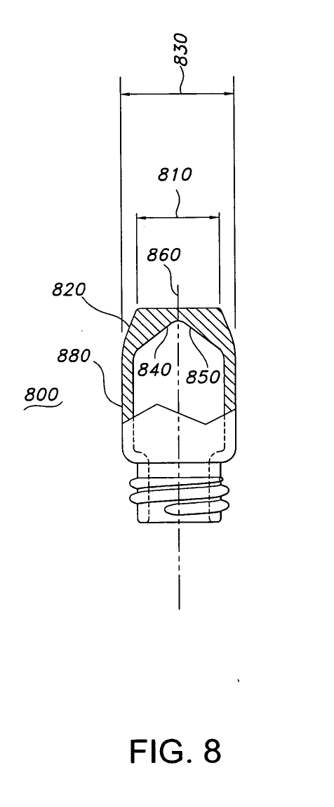

FIG. 8 illustrates vial 800 form by an exemplary method and device according to an embodiment of the present invention and having an interior volume of approximately 2.0 mL. Vial 800 of FIG. 8 has a 15.0±0.40 mm outer diameter 830 forming a 1.20±0.01 mm wall 880. Although the overall dimensions of vial 800 are generally smaller than the 4.0 mL vial shown in FIG. 1, vial 800 has a base 810 that remains flat, and a base wall 820 that extends from base 810 to the outer diameter 830 to form an angle of approximately 18°±5°. Base 810 also defines an interior cavity having surfaces 840 and 850 that converge to point 860 forming a generally concave shape.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for making a vial from a pre-form having interior and exterior base portions and an interior and exterior side wall, the method comprising the steps of:
heating the pre-form to a temperature at or above the lowest temperature at which the pre-form flows;
contacting the interior base portion with a mandrel;
shaping the exterior side wall of the pre-form with at least one roller; and
forming a finished exterior base portion of the vial with base forming means when the pre-from is at or above the temperature achieved in said heating step to form the finished vial base.

2. The method of claim 1, wherein the steps of contacting, shaping, and forming are performed concurrently.

3. The method of claim 1, wherein the step of inserting the mandrel forms a V-shaped interior base portion of the finished vial.

4. The method of claim 1, wherein the step of inserting the mandrel and the step of contacting the exterior base portion occur concurrently and coaxially.

5. The method of claim 1, wherein the step of shaping the exterior side wall of the pre-form comprises imparting a rotational movement on the pre-form with the at least one roller.

6. The method of claim 1, wherein the step of shaping the exterior side wall of the pre-form comprises imparting a rotational movement on the pre-form with two rollers diametrically disposed about the pre-form.

7. The method of claim 1, wherein the step of shaping the exterior side wall includes forming a beveled edge extending from the exterior side wall to the exterior base portion with the at least one roller.

8. The method of claim 1, wherein the heating step includes heating the pre-form to a temperature in the range of about X ° F to about X ° F.

9. The method of claim 8, wherein the temperature is X ° F.

10. The method of claim 1 further comprising the step of thermally cutting a predetermined length of tubing corresponding to a predetermined height of the finished vial.

11. The method of claim 1, wherein the pre-form is at least one of a glass or polymeric material.

12. The method of claim 1 further comprising forming a finish on the pre-form on an end opposite the exterior base portion.

13. The method of claim 1 further comprising annealing the finished vial.

14. An apparatus for making a vial from a pre-form having interior and exterior base portions, an interior and exterior side wall, and a finish, comprising:
a heat source for raising the pre-form to a temperature at or above the lowest temperature at which the pre-form flows;
at least one roller disposed adjacent the heat source, the at least one roller adapted to shape the exterior side wall of the pre-form;
a mandrel adapted to be inserted through the finish and contact the interior base portion; and
means for forming the exterior base portion of the pre-form, the means disposed coaxially with, and opposed to, the mandrel.

15. The apparatus of claim 14, wherein the mandrel comprises a pin having a V-shaped tip to form a V-shaped recess in the interior base portion when the tip contacts the interior base portion.

16. The apparatus of claim 14, wherein the at least one roller comprises a first and second roller, the first roller is diametrically opposed the second roller in between which is disposed the pre-form, and wherein the first and second rollers are disposed adjacent the heat source.

17. The apparatus of claim 14, wherein the at least one roller comprises a base having a diameter and a top having a diameter that is dimensionally different than the base diameter.

18. The apparatus of claim 14, wherein the heat source is at a temperature in the range of about X ° F to about X ° F.

19. The apparatus of claim 14, wherein the heat source is at a temperature of about X ° F.

20. The apparatus of claim 14, wherein the means for shaping the base is a high temperature resistant base forming rod constructed from graphite.

21. A glass extraction vial having a flat, transparent base and a finish made by the process comprising concurrently performing the steps of:
providing a pre-form having interior and exterior base portions and an interior and exterior side wall;
heating the pre-form to a temperature at or above the temperature at which the pre-from flows;
inserting a mandrel into the pre-form through the finish to a point such that the mandrel contacts the interior base portion;
shaping the exterior side wall of the pre-form with at least one roller; and
forming the exterior base portion of the pre-form when the pre-form is at the temperature achieved in the heating step to form the flat, transparent base of the glass extraction vial.
